(19) United States
(12) Patent Application Publication
(10) Pub. No.: US 2002/0047801 A1
(43) Pub. Date: Apr. 25, 2002

(54) Device for measuring the movements of a moving object, especially in a hostile environment

(76) Inventors: Jean-Benoit Laurent Agnani, Saint Remy les Chevreuse (FR); Jean-Claude Beyer, Draveil (FR); Bruno Pierre Marie Patin, Fontenay aux Roses (FR); Eric Robert, Les Ulis (FR)

Correspondence Address: JACOBSON HOLMAN PLLC, 400 SEVENTH STREET N.W., SUITE 600, WASHINGTON, DC, 20004, US

(21) Appl. No.: 09/942,946

(22) Filed: Aug. 31, 2001

Related U.S. Application Data
(63) Continuation of application No. PCT/FR00/00535, filed on Mar. 3, 2000.

(30) Foreign Application Priority Data
Mar. 4, 1999 (FR) 99 02702

(51) Int. Cl. G01S 5/02; G01S 3/02

(52) U.S. Cl. 342/424; 342/465

(57) ABSTRACT

The present invention relates to a device for measuring the movements of a moving object, especially in a hostile environment, starting from a predetermined initial position, comprising:

a) at least one transmitter (16) of a radioelectric frequency, integral with said object,

b) first and second receiving bases (B₁, B₄) sensitive to said radioelectric frequency and each comprising a pair of antennas disposed in fixed positions in a same plane, at a predetermined distance from each other, in order to deliver electrical signals representative of the radioelectric signals received and interferometric means fed by said electrical signals to provide continuously a measurement of the current position of the projection of said transmitter in said plane, from the departure of said moving object from said predetermined initial position, and

c) a third receiving base (B₆) comprising antennas aligned on an axis perpendicular to said plane in order to deliver a measurement of the position of the projection of said transmitter on said axis.

This application is a continuation of International PCT application NO PCT/FR 00/00535 filed on Mar. 3, 2000, which designated the United States of America.

### FIELD OF THE INVENTION

The present invention relates to a device for measuring the movements of a moving object, especially in a hostile environment and, more particularly, such a device applied to tracking the movements of a rocket starting from its take-off. BACKGROUND OF THE INVENTION

Rockets are known, such as satellite or space vehicle launchers for example, which take off from a launching pad equipped with various equipment or structures adjacent to the launcher itself. In particular, this is the case of the Ariane 5 launching pad designed, developed and constructed by the Centre National d'Etudes Spatiales and the European Space Agency which includes ducts for the evacuation of gases surrounding the nozzle of the first cryogenic stage of that launcher and those of the two powder booster engines mounted on that stage. During the take-off of the launcher, the nozzles must obviously come out of their respective shafts without risk of touching the sides of the shafts because of a lateral shift of the trajectory of the launcher with respect to its nominal vertical trajectory. For reasons of safety, this therefore results in undersizing the maximum diameter of the nozzles in order to minimize these risks and this is detrimental to the thrusts delivered by these engines.

A precise knowledge of the movements of the launcher during the first seconds of its take-off would make it possible to maximize the diameter of each nozzle with respect to that of the shaft housing it, and therefore to maximize the power developed by each engine, for a given diameter of the gas evacuation ducts.

Taking account of the relative distortions of the various components of the launcher, resulting from thrust and pressure effects, from the cooling of the cryogenic stage and the degrees of freedom of certain mechanical parts, an accurate measurement of these movements requires that the measuring means be disposed in the bottom part of the launcher.

Various devices have been envisaged for measuring these movements, in particular a device comprising wire spoolers attached to the launcher and means of continuously measuring the lengths of the spooled out wires, in several directions in space. It has also been proposed to use a recording of video images of the launcher during take-off and a processing of the recorded images revealing the movements of the launcher, or even the use of infrared or ultrasonic transmitters on the launcher and means of detection of the movements of these transmitters. It has also been thought to use trajectory data provided by the launcher's inertial guidance system. The use of an argon laser radiation transmitter, associated with appropriate reflectors, has also been envisaged.

Upon analysis, these various devices prove to be unsatisfactory in the very hostile environment to which they are subjected during the launcher's take-off, because of the enormous releases of various products (smokes, vapors, aluminum powder, etc.) at the base of the launcher, caused by the ignition of the engines and by the very powerful heat, acoustic and optical radiations, in particular, which are associated with these releases.

### SUMMARY OF THE INVENTION

The objective of the present invention is therefore to produce a device for measuring movements of a moving object such as a satellite or space vehicle launcher, capable of providing an accurate measurement of the movements of the base of such a launcher in the hostile environment which prevails around that base, during the few seconds following the take-off of the launcher.

This objective of the invention is achieved, as well as others that will appear on reading the following description, with a device for measuring the movements of a moving object, starting from a predetermined initial position, characterized in that it comprises:

a) at least one transmitter of a radioelectric frequency, integral with said object,

b) at least one receiving base sensitive to said radioelectric frequency and comprising a pair of antennas disposed in fixed positions at a predetermined distance from each other, in order to deliver electrical signals representative of the radioelectric signals received and interferometric means fed by said electrical signals to provide continuously a measurement of the current position of said transmitter, from the departure of said moving object from said predetermined initial position.

As will be seen below in detail, the measurement of the movements of the moving object by radioelectric wave interferometry proposed by the present invention makes it possible to track the movements of the moving object with high accuracy, including when the latter is subjected to the hostile environment described above.

According to a preferred embodiment of the invention, the device comprises first and second receiving bases disposed in a same plane, said interferometric means delivering a measurement of the position of the projection of said transmitter in said plane. It furthermore comprises a third receiving base comprising antennas aligned on an axis perpendicular to said plane in order to deliver a measurement of the position of the projection of said transmitter on said axis.

In its application to the tracking of the position of a rocket taking off substantially vertically from a horizontal pad, the device comprises a second transmitter of a second radioelectric frequency distinct from the one transmitted by the first transmitter, said second transmitter being mounted on said rocket at a point horizontally distant from the point at which the first transmitter is mounted, said second transmitter being associated, like the first one, with three receiving bases of said second radioelectric frequency and with interferometric means for processing the signals delivered by said receiving bases in order to deliver a measurement of the position of said second transmitter after the take-off of the rocket.

### DESCRIPTION OF THE DRAWINGS

Other features and advantages of the present invention will appear on reading the following description and on examining the accompanying drawing in which:

FIG. 1 is a diagram illustrating the principle of the interferometric measurement used by the device according to the invention,

FIG. 2 shows the positioning of the transmitter or transmitters forming part of the device according to the invention, on a moving object consisting, by way of example only, of said Ariane 5 launcher,

FIG. 3 is a plan view of the arrangement of transmitters and receiving bases of the device according to the invention, installed on a launching pad of the launcher shown in FIG. 2,

FIG. 4 is a plan view of the device according to the invention, and

FIG. 5 is a functional diagram of the signal processing means forming part of the device according to the invention.

### DETAILED DESCRIPTION

Reference is made to FIG. 1 of the accompanying drawing in order to describe briefly the principle of the interferometric measurement used in the device according to the invention.

At 1 there is represented a moving transmitter of radioelectric waves having a predetermined frequency corresponding to a wavelength λ. Two fixed radioelectric wave receiving antennas 2 and 3, of any appropriate type, are disposed at a distance L from each other, in the field of radiation of the moving transmitter 1, by hypothesis in the plane passing through that transmitter and the antennas 2, 3. The direction of the transmitter 1 is referenced by its angle θ with the normal, in the plane defined above (the plane of FIG. 1) to the section of straight line delimited by the positions of the receivers 2 and 3, at its center 4.

The two antennas 2, 3 thus make it possible to form a “receiving base” which delivers electrical signals at the frequency of that of the transmitter 1. It is demonstrated that the phase φ of the signal transmitted by the antenna 3, chosen as the measuring antenna, with respect to the signal from the “reference” antenna 2, is given approximately by the equation:

$$ϕ = \frac{2 π L \cdot sin θ}{λ}$$

Thus, a measurement of this phase φ makes it possible to calculate the angle θ and therefore the direction of the transmitter 1.

Only the direction of the transmitter is thus determined and not its position along that direction. It is understood however that by taking the position of the transmitter 1 using two receiving bases instead of one that this position is located at the intersection of two directions each of which is detected by one of the two receiving bases. This is the principle of tracking the position of the transmitter used by the device according to the present invention.

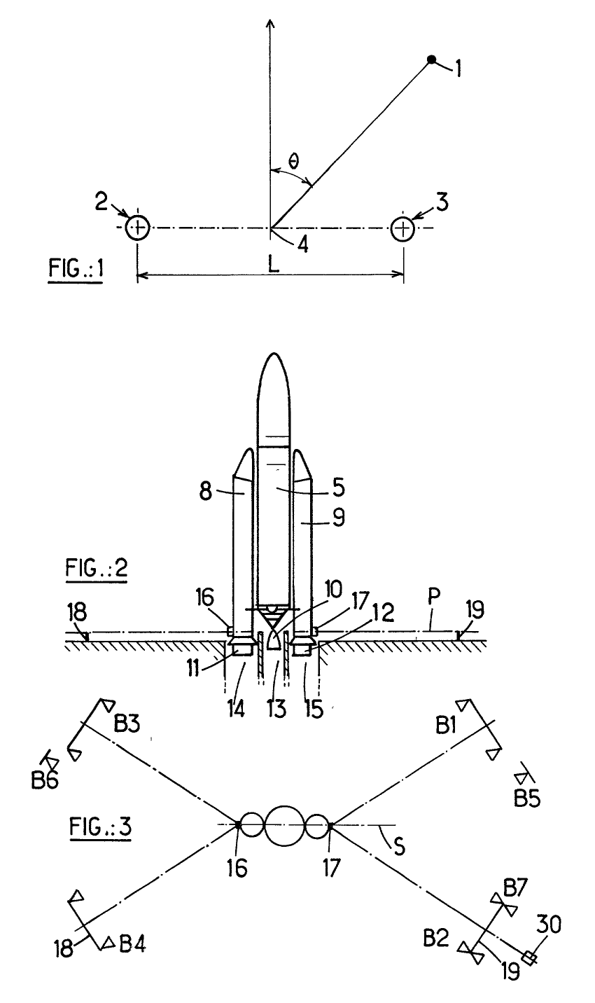

Reference is now made to FIGS. 2 to 4 of the accompanying drawing in order to describe the structure and the functioning of the device according to the invention.

In FIG. 2, there has been shown a diagrammatic view in elevation of the Ariane 5 launcher, chosen by way of illustrative and nonlimiting example only, the device according to the invention being adaptable to any launcher, rocket or other moving object, as will be obvious from the continuation of the present description.

In this FIG. 2, it appears that the launcher shown comprises, as is well known, a first cryogenic stage 5 and two powder booster engines 8, 9, fixed to the casing of the first stage.

At the bottom of the latter there is a gas ejection nozzle. Similarly, the booster engines 8, 9 are fitted with nozzles 11, 12 respectively.

When the launcher is mounted on its launching pad, one or more of these nozzles 10, 11, 12 can be housed inside gas evacuation ducts such as 13, 14, 15 respectively, as shown in FIG. 2, these ducts allowing the remote evacuation of the products of combustion of the propellants used.

As seen above, it is the objective of the present invention to measure accurately the movements of the launcher after the firing of the cryogenic stage 5 and of the booster engines 8, 9 in such a way as to make it possible to optimize the sizing of the nozzles whilst avoiding any risk of contact between these nozzles and their respective gas evacuation ducts, during the emergence of these nozzles from these ducts.

As seen above, the use of a single transmitter and a single receiving base makes it possible to track the changes of a direction passing through the transmitter, in a plane defined by that transmitter and the antenna pair. The use of a second receiving base makes it possible to track the position of the transmitter in this plane.

In certain applications of the invention to the tracking of moving objects whose movements are limited, the device according to the invention will be able to offer a simple basic structure, such as one of the two structures mentioned above.

In general, the position of a solid object in a three-dimensional space being defined by that of three nonaligned points of the solid object, the device according to the invention should comprise three transmitters fixed to the solid moving object to be tracked, each transmitter being associated with three receiving bases disposed in such a way as to deliver signals suitable for calculating the coordinates of the three transmitters, along three directions in space.

In the particular application of the present invention to the tracking of the movements of a launcher such as the Ariane 5, during the few seconds following its take-off which are necessary so that the nozzles 10, 11, 12 of the engines emerge from their respective shafts 13, 14, 15, two transmitters suffice, as explained below.

In the diagrams shown in FIGS. 2 and 3, it appears that these two transmitters 16 and 17 are disposed at the base of the powder engines 8, 9, above the nozzles 11, 12 respectively, in a plane of symmetry S of the launcher passing through the three longitudinal axes of the first stage 5 and of the booster engines 8, 9 respectively, and in a horizontal plane P.

With each transmitter 16, 17 there are associated three receiving bases, making it possible to measure the movements of the transmitter in space, after firing the launcher.

It is thus that the bases B₃ and B₄ are disposed symmetrically with respect to the plane S, in the plane P, in order to measure the position of the projection of the transmitter 16 in a horizontal plane, whilst a base B₆, composed of two antennas aligned on a vertical axis, makes it possible to measure the position of the projection of the transmitter on said axis, that is to say the altitude of the transmitter 16.

The bases B₁, B₂ and B₅ have functions identical to those of the bases B₃, B₄, B₆ respectively, for the transmitter 17.

By spacing the bases B₁ to B₄ sufficiently with respect to the launcher, it can be understood that the plane defined by a transmitter and the two bases associated with it in the plane P, hardly separates from this plane P during the first seconds of the take-off of the launcher.

As shown diagrammatically in FIG. 2, the bases B1 to B6 are supported by gantries such as 18, 19, above the surface of the pad.

It is understood that the device according to the invention makes it possible to track the position of the section of straight line defined by the positions of the transmitters 16, 17 and in particular, a rotation of this section in a horizontal plane, a rotation which could cause collisions between the nozzles 10, 11, 12 and the shafts 13, 14, 15 from which these nozzles emerge during the take-off of the launcher.

It will be noted, in particular, that the sensitivity of the detection of this rotation is maximized by disposing the two transmitters 16, 17, as shown, at two points horizontally separated by a maximum distance.

As soon as the nozzles have emerged from their respective gas evacuation ducts, this monitoring becomes useless, that is to say as soon as the launcher has risen by a few meters. During this short travel, a possible rotation of the launcher about an axis passing through the positions of the transmitters 16, 17 would have a very low amplitude which would be negligible with regard to the problem of detecting a risk of nozzle/shaft collision. That is why the presence of a third transmitter on the launcher is not necessary in the above-described application of the device according to the invention.

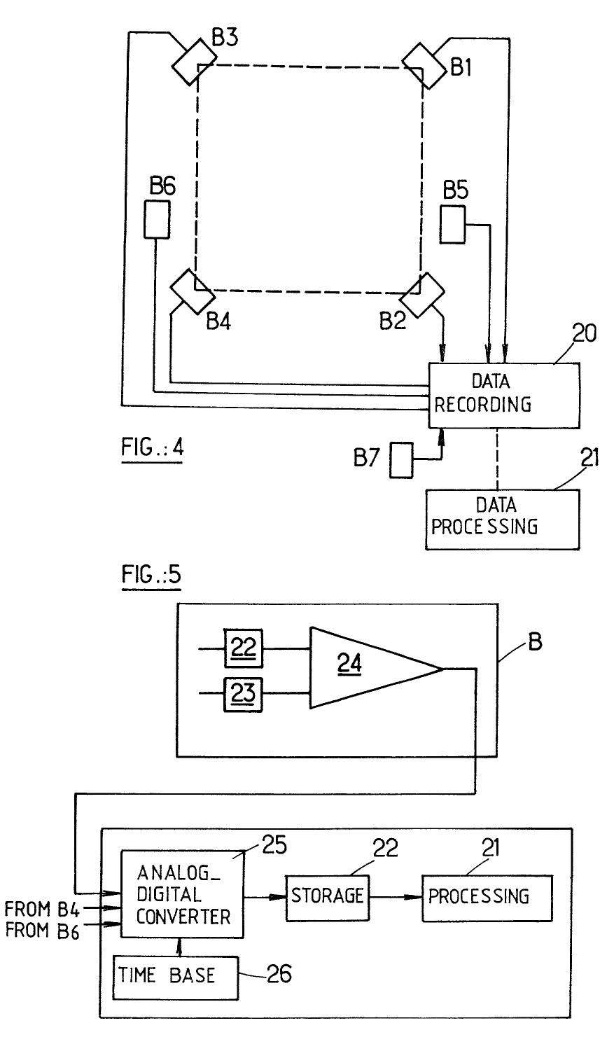

The signals delivered by the antennas of the bases B1 to B6 are delivered, as shown in FIG. 4, to a central data recording station 20, before being retransmitted to another central station 21 for the remote processing of this data.

The functional diagram of FIG. 5 shows the principal steps of the processing of the signals delivered by the bases. FIG. 5 is a diagrammatic representation of the processing of the signals delivered by the bases B₃, B₄, B₆ associated with the transmitter 17 alone, the processing of the signals delivered by the bases B₁, B₂, B₅ being identical.

Thus it is that in each of the bases B₃, B₄, B₆, the signals delivered by the antennas are processed by interferometric means (22, 23, 24) in such a way as to be shaped in 22, 23 and then processed in a phase comparator 24 which delivers a signal representative of an angle such as the angle 0 described with reference to FIG. 1. After digitizing in an analog-digital converter 25 controlled by a time base 26, the three signals are recorded at 27 so that they can then be processed, for example remotely, in order to derive from them the trajectories followed by the nozzles during their emergence from their respective shafts. The space necessary for an emergence without collision between the nozzles and their gas evacuation ducts is then determined and consequently the diameters of the nozzles are optimized.

Very advantageously, the interferometric measurement of the movements of the launcher on the basis of radioelectric waves, according to the present invention, makes it possible to avoid all the disadvantages which affect the devices mentioned in the preamble of the present description, when these devices are subjected to hostile environments such as that of a launcher during take-off. By an appropriate choice of their frequencies, is it possible to make the radioelectric waves virtually insensitive, in effect, to any interference by the powerful releases of gas and vapors or by the strong thermal, optical and acoustic radiations which then develop in this environment.

As the signal-to-noise ratio of the measurements made is therefore high, high-accuracy measurements are obtained. Thus it is that with the transmitters 16 and 17 operating at different fixed frequencies in X band in order to avoid any interference, four receiving bases B₁ to B₄ disposed at about 30 meters from the launcher, the two antennas of each base being disposed at 3 meters from each other, it has been possible to measure the trajectory of each transmitter with an accuracy of ±5 mm over the first two meters of that trajectory, traveled along in about 1.3 seconds. It has also been possible to measure the altitude of the launcher up to 5 meters.

In the main altitude range in question (0-2 meters) the effect of this altitude on the accuracy of the measurements of the positions of the transmitters is negligible.

As seen above, the antennas of the bases B₁ to B₄ are mounted on gantries (see FIG. 2). At take-off, the latter are likely to vibrate under the forces applied to them by the gases and vapors exhausting from the nozzles of the rockets, these vibrations therefore falsifying the measurements made.

According to the present invention, account is taken of these vibrations by measuring them using a transmitter of radioelectric waves 30 (see FIG. 3) similar to the transmitters 16, 17, the transmitter 30 being firmly fixed to an antivibration support, and by measuring the vibrations of one of the gantries, for example the gantry 19 (see FIG. 3) using a receiving base B₇ mounted on that gantry. A signal is derived from this measurement making it possible to correct the measurements made using the other bases in order to make these measurements independent of the vibrations of the gantries.

It will be observed however that, in certain situations, in particular when these vibrations are oriented perpendicularly to the axis of the base in question, the effects of these vibrations on the measurements made can act against each other and therefore cancel each other out, which makes any correction of no use.

The invention is not of course limited to the embodiment described and shown which was given only by way of example. Thus it is that other configurations of transmitters and antennas and other frequencies will be able to be envisaged by those skilled in the art, without departing from the present invention, insofar as the method of interferometric measurement of radioelectric waves described above is retained.

Similarly, the invention is not limited to the tracking of movements of a rocket or of a space launcher in the seconds following its take-off. On the contrary, it extends to the tracking of any moving object leaving a position of rest, such as for example an aircraft ejection seat under test.

1. A device for measuring the movements of a moving object, especially in a hostile environment, starting from a predetermined initial position, comprising:
a) at least one transmitter (16) of a radioelectric frequency, integral with said object,
b) first and second receiving bases (B₃, B₄) sensitive to said radioelectric frequency and each comprising a pair of antennas disposed in fixed positions in a same plane, at a predetermined distance (L) from each other, in order to deliver electrical signals representative of the radioelectric signals received and interferometric means (22, 23, 24) fed by said electrical signals to provide continuously a measurement of the current position of the projection of said transmitter in said plane, from the departure of said moving object from said predetermined initial position,
characterized in that it comprises a third receiving base (B₆) comprising antennas aligned on an axis perpendicular to said plane in order to deliver a measurement of the position of the projection of said transmitter on said axis.

2. The device as claimed in claim 1, characterized in that said axis is vertical.

3. The device as claimed in claim 2, applied to the tracking of the position of a moving object consisting of a rocket (5 to 9) taking off vertically from a horizontal pad, characterized in that it comprises a second transmitter (17) of a second radioelectric frequency distinct from the one transmitted by the first transmitter (16), said second transmitter (17) being mounted on said rocket at a point horizontally distant from the point at which the first transmitter (16) is mounted, said second transmitter (17) being associated, like the first one, with three receiving bases (B₁, B₂, B₅) of said second radioelectric frequency and with interferometric means for processing the signals delivered by said receiving bases in order to deliver a measurement of the position of said second transmitter (17) after the take-off of the rocket.

4. The device as claimed in claim 3, characterized in that said transmitters (16, 17) are disposed in a same horizontal plane (P) at two points of the rocket having a maximum separation in said plane.

5. The device as claimed in claim 4, applied to a rocket comprising at least one nozzle (10; 11; 12) disposed, before take-off, in a gas evacuation duct (13; 14; 15) installed on the launching pad, characterized in that said transmitters (16, 17) are disposed on said rocket, in the vicinity of said nozzle (10; 11; 12).

6. The device as claimed in any one of claims 3 to 5, characterized in that said receiving bases (B₁ to B₆) are mounted on gantries fixed on the launching pad and in that means (B₇, 30) are provided for detecting the vibrations of said gantries during the take-off of the rocket and for correcting the measurements made by said interferometric means according to said vibrations.
